(19) United States
(12) Patent Application Publication
(10) Pub. No.: US 2006/0062657 A1
(43) Pub. Date: Mar. 23, 2006

(54) Hitch mounted motorcycle carrier

(76) Inventors: Brenton S. Davis, Redlands, CA (US); Howard Sukenik, Redlands, CA (US)

Correspondence Address: Richard C. Litman;LITMAN LAW OFFICES, LTD., P.O. Box 15035, Arlington, VA, 22215, US

(21) Appl. No.: 10/944,779

(22) Filed: Sep. 21, 2004

(51) Int. Cl. B60P 9/00

(52) U.S. Cl. 414/462

(57) ABSTRACT

The hitch mounted motorcycle carrier includes a hitch engaging body, which has a hitch engaging member configured to be removably joined to a trailer hitch receiver disposed on a motor vehicle and a forward support column extending upwardly from one end of said hitch engaging member. A carrier housing, which has a carrier platform for carrying a motorcycle thereon. At least one control arm that has a first end portion and a second end portion, the first end portion being rotatably connected to the hitch engaging body, and the second end portion being rotatably connected to the carrier housing. At least one hold down bracket positioned on the carrier platform for securing the motorcycle to the carrier platform and an actuating assembly connected to at least one control arm and adjoined to the hitch engaging body for lifting and lowering the motorcycle.

### BACKGROUND OF THE INVENTION

1. Field of the Invention

The present invention relates to a carrier for transporting motorcycles, and more specifically, to a hitch mounted motorcycle carrier removably mountable to a vehicle receiver hitch.

2. Description of the Related Art

A variety of carrier devices have been devised for attachment to a vehicle for carrying a motorcycle. However, some devices are not adaptable to engage a conventional trailer hitch receiver of a vehicle. Still others are constructed of heavy weighted material, such as steel tubing, that makes removal of the carrier from the receiver hitch difficult. For example, a web page published at the website userpages.motojackrack.com, dated Apr. 26, 2004, illustrates such a device made from steel tubing.

Some conventional carrier devices use complicated hold down brackets to secure the motorcycle to the carrier. While other carrier devices have hold down brackets that are in the way when working on the motorcycle. Still other devices use multiple components to lift the motorcycle for transport.

Accordingly, there is a need for a hitch mounted carrier that is adaptable to be removably joined to a conventional receiver hitch of a vehicle. Additionally, there is a need for a hitch mounted motorcycle carrier that permits easy loading and unloading of the motorcycle, which utilizes a minimal amount of material to create a strong, lightweight carrier device that is easier to transport. Furthermore, there is a need for hold down brackets, which will securely hold the motorcycle to the carrier during transport and which will allow the motorcycle to be worked on while the motorcycle is secured to the carrier device. Thus, a hitch mounted motorcycle carrier solving the aforementioned problems is desired.

### SUMMARY OF THE INVENTION

A hitch mounted motorcycle carrier for transporting a motorcycle includes a hitch engaging body and a carrier housing, which has a rearward support column securely fixed to a carrier platform for transporting the motorcycle. The hitch engaging body has a hitch engaging member that is configure to be removably joined to a trailer hitch receiver of a vehicle. A forward support column is fixed to one end of the hitch engaging member and extends in an upwardly direction therefrom. A movable control arm assembly is disposed between the hitch engaging body and the carrier housing.

The movable control arm assembly includes two upper and lower control arms. Each one of the upper and lower control arms have a first end portion, which is rotatably connected to the hitch engaging body and a second end portion, which is rotatably connected to the carrier housing. The motorcycle is secured to the carrier platform by at least one hold down bracket, which securely holds a foot peg of the motorcycle.

An actuating assembly is connected to the lower control arms and adjoins the forward support column in a manner that operable engages the hitch engaging body to effectuate a movement of the carrier housing with respect to the hitch engaging body, which results in lifting and lowering the motorcycle. A locking member inserted through the lower control arms and the forward support column locks the carrier housing in an upright position for transporting the motorcycle.

The carrier platform can be lowered towards ground level for loading the motorcycle. The motorcycle frame is disposed on the carrier platform and positioned on cushioning strips, which are attached to the carrier platform. The cushioning strips help alleviate the vibration between the carrier platform and the motorcycle. Two hold down brackets are connected to the foot pegs of the motorcycle and tighten down to the carrier platform by means of a bracket nut. The tightening of the hold down brackets to the carrier platform pulls the motorcycle firmly against the carrier platform. The hold down brackets are designed and configured to engage and securely hold the foot pegs of the motorcycle. The motorcycle is then lifted to an upright position and locked into position. Advantageously, the hitch mounted motorcycle carrier in an upright position provides a stand for working on the motorcycle.

### BRIEF DESCRIPTION OF THE DRAWINGS

FIG. 1 is an environmental, perspective view of a hitch mounted motorcycle carrier according to the present invention.

FIG. 2 is a perspective view of a hitch mounted motorcycle carrier according to the present invention.

FIG. 3 is a perspective view of a hitch mounted motorcycle carrier according to the present invention in which the carrier is shown in an upright locked position for carrying a motorcycle.

FIG. 4 is a perspective view of a hitch mounted motorcycle carrier according to the present invention in which the carrier is shown in a downward position for loading a motorcycle.

FIG. 5 is a side view of a hitch mounted motorcycle carrier according to the present invention.

FIG. 6 is a partial bottom perspective view of a hitch mounted motorcycle carrier according to the present invention, showing the diagonal braces and hold down members.

Similar reference characters denote corresponding features consistently throughout the attached drawings.

### DETAILED DESCRIPTION OF THE PREFERRED EMBODIMENTS

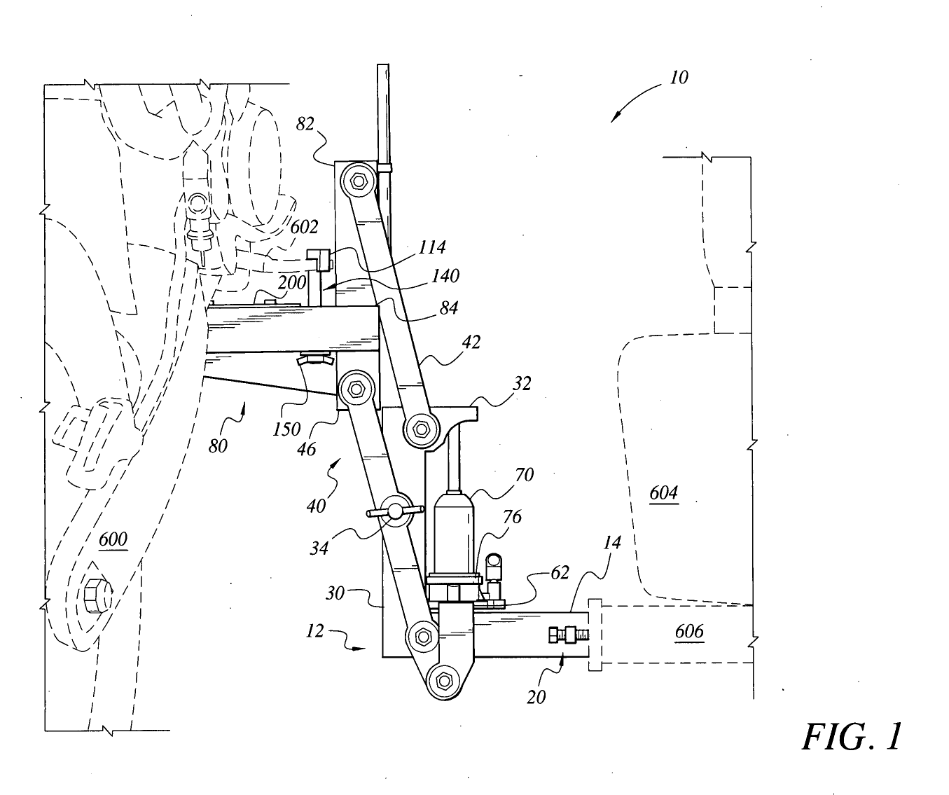

Attention is first directed to FIG. 1, wherein a hitch mounted motorcycle carrier, generally indicated at 10, for transporting a motorcycle embodies the principles of the present invention. The hitch mounted motorcycle carrier 10 includes a hitch engaging body 12 that is configured to be removably joined to a trailer hitch receiver 606 of a vehicle 604, a carrier housing 80 which has a carrier platform 84 securely fixed to a rearward support column 82 to transport a motorcycle 600, at least one hold down bracket 140 which securely holds foot peg 602 of the motorcycle 600, a movable control arm assembly 40 configured to be rotatably connected to the carrier housing 80 and the hitch engaging body 12, and an actuating assembly 40 constructed and arranged to be operable connected to the movable control arm assembly 40 and the hitch engaging body 12 for moving the carrier housing up and down with respect to the hitch engaging body 12.

As illustrated in FIG. 1, the hitch mounted motorcycle carrier is in an upright position for transporting the motorcycle 600. A locking bar 34 locks the movable control arm assembly 40 to the hitch engaging body 12 for maintaining the carrier housing in an upright position. A stabilizing mechanism 20 is disposed on the hitch engaging body 12 and adjoins the trailer hitch receiver 606 of the vehicle 604 to tighten the slack that may occur between the hitch engaging body 12 and the trailer hitch receiver 606.

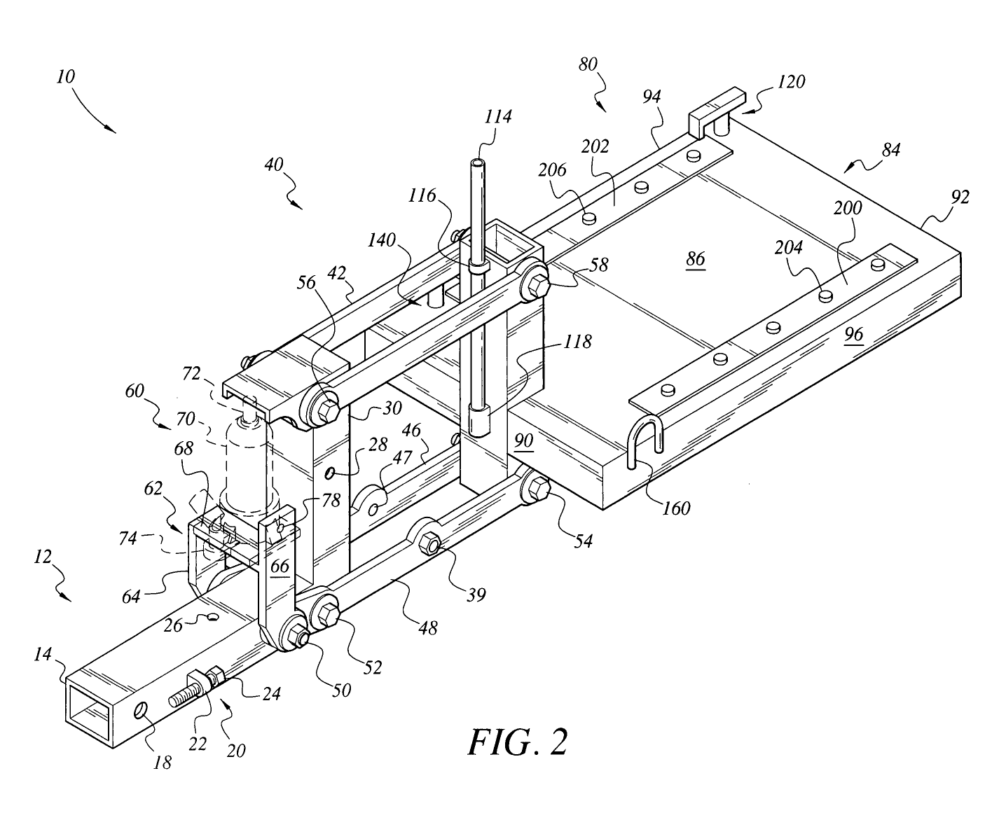

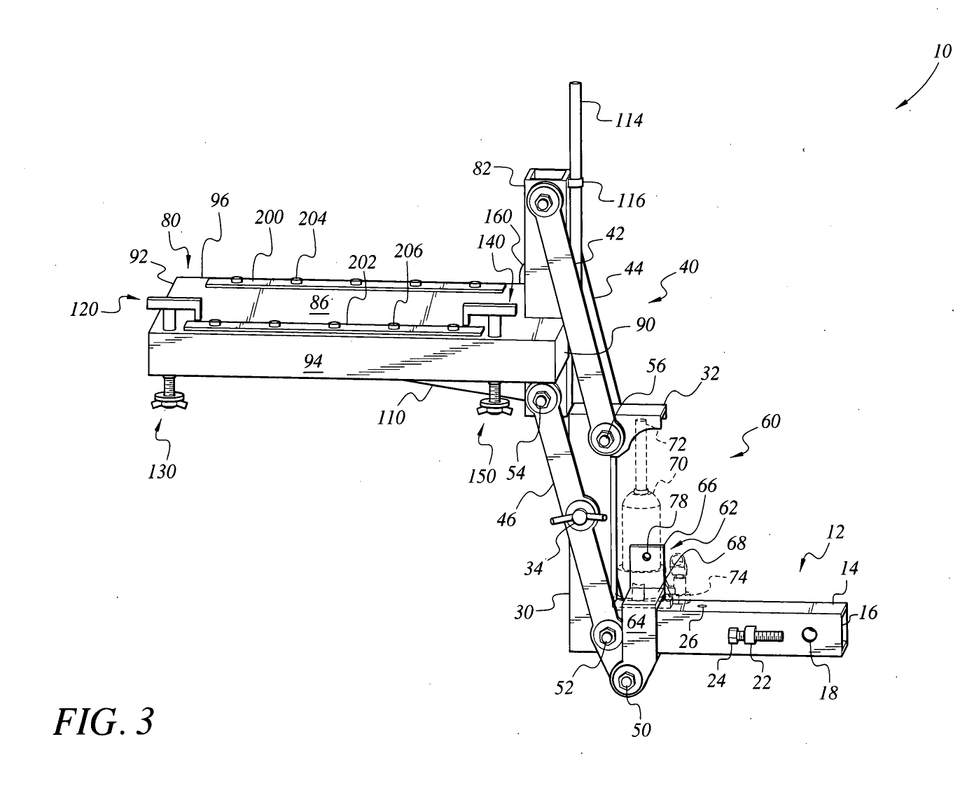

As shown in FIGS. 2-3, the hitch engaging body 12 includes a hitch engaging member 14 and a forward support column 30 that is fixed to one end of the hitch engaging member 14 and in which the forward support column 30 extends in an upwardly direction from the hitch engaging member 14. The hitch engaging member 14 has a hitch engaging end 16, which is configured to removably join to the trailer hitch receiver 606. The hitch engaging end 16 has a trailer hitch receiver hole 18 which aligns with the trailer hitch receiver hole (not shown) to receive a trailer hitch security pin (not shown) that securely holds the hitch engaging end 16 to the trailer hitch receiver 606. Alternatively, the hitch engaging member 140 is a square or rectangular tube which defines a receiver hitch bar that is slidably engaged into the trailer hitch receiver 606.

The hitch stabilizing mechanism 20 includes a threaded collar 22 fixed to the hitch engaging end 16 and a bolt 24, which is attached to the threaded collar 22 and engages the trailer hitch receiver 606 to tighten the hitch engaging end 16 against the trailer hitch security pin (not shown), which results in removing the slack therein.

The forward support column 30 has an upper top plate 32 fixed to an upper portion of the forward support column 30. The upper top plate 32 extends forwardly from the forward support column 30 to a position that is over a hydraulic jack 70. A top portion 72 of the hydraulic jack 70 adjoins the upper top plate 32. A bottom portion 74 of the hydraulic jack 70 is securely mounted to a saddle 62 of the actuating assembly 60. As the top portion 72 of the hydraulic jack 70 extends against the underside of the upper top plate 32, the hydraulic jack 70 moves in a downward direction against the saddle 62 such that the actuating assembly 60 effectuates a movement of the carrier housing 80 with respect to the hitch engaging member which results in lifting the carrier housing 80 in an upright position (as shown in FIG. 3).

A base wall 68 and two opposing sides walls 64 and 66, respectively, are integrally connected to the base wall 68 and extend in a downwardly direction therefrom to define a U-shaped saddle 62, which supports the hydraulic jack 70. The side wall 66 also extends in an upwardly direction from the base wall 68 to define an upper section of the side wall 66. The upper section of the side wall 66 has a hole 78 that is configured to receive a hydraulic jack clamp 76, which is attached to the side wall 66 to secure the hydraulic jack 70 to the saddle 62. Preferably, the saddle 62 is laser cut from a sheet of steel and bent into a flat U-shaped saddle, which has an ear welded to side wall 66 to define the upper section of the side wall 66. The hole 76 extends through the ear and is configured to receive the hydraulic jack clamp 76, which attaches the hydraulic jack 70 to the saddle 62.

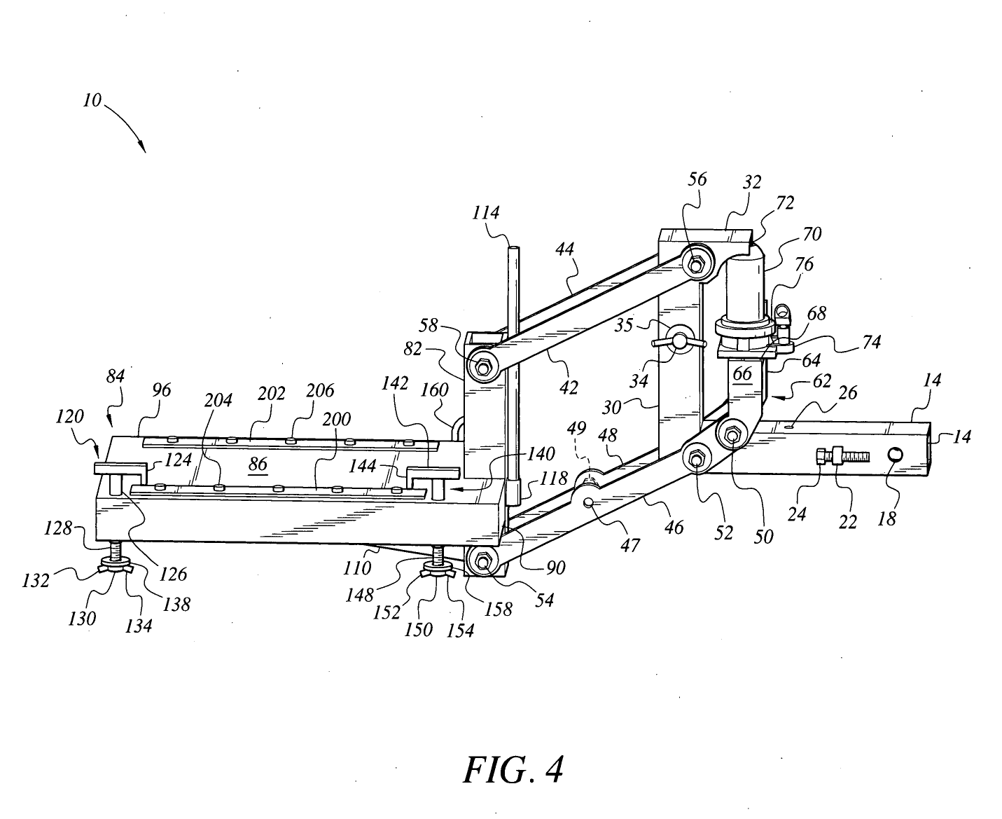

As illustrated in FIGS. 3-4, the hydraulic jack 70 actuates the movable control arm assembly 40, which rotates the carrier housing 80 with respect to the hitch engaging member 14. In more detail, the movable control arm assembly 40 includes a pair of upper control arms 42, 44 and a pair of lower control arms 46, 48. The upper and lower control arms 42, 44, 46, 48, respectively, are designed and configured to have a forward end portion and a rearward end portion, which have a hole extending therethrough for receiving a fastener, such as a bolt. The upper and lower control arms 42, 44, 46, 48 are preferably laser cut from steel to define a dog-bone shape.

The forward end portions of the upper control arms 42, 44 extend on opposite sides of an upper section of the forward support column 30 and are rotatably connected to the forward support column 30 by means of a pivot fastener 58, such as a pivot bolt or pin. The rearward end portions of the upper control arms 42, 44 extend on opposite sides of an upper section of a rearward support column 82 of the carrier housing 80 and are rotatably connected to the rearward support column 82 by means of a pivot fastener 58, such as a pivot bolt or pin.

The forward end portions of the lower control arms 46, 48 extend on opposite sides of a lower section of the forward support column 30 and are rotatably connected to the hitch engaging member 14 by means of a pivot fastener 52, such as a pivot bolt or pin. The forward end portions of the lower control arms 46, 48 are also connected to the opposing side walls 64, 66 of the saddle 62 by fastener 50. The rearward end portions of the lower control arms 46, 48 extend on opposite sides of a lower section of the rearward support column 82 of the carrier housing 80 and are rotatably connected to the rearward support column 82 by means of a pivot fastener 54, such as a pivot bolt or pin.

The lower control arms 46 and 48 have a hole 47 and 49, respectively, that are disposed in alignment position with hole 28, which extends through the forward support column 30. Holes 47, 28, and 49 are constructed and arranged to be in alignment with each other to receive a locking member when the carrier platform 84 is in an upright position. The locking member is preferably a locking bar 34 with a threaded end portion, which fastens to a locking bar nut 39. Opposite the threaded end portion of the locking bar 34 is a handle end portion, which provides a means to fasten the locking bar 34 to the locking bar nut 39. Preferably, the locking bar nut 39 is positioned on the lower control arm 48 such that when the carrier housing is in the upright position the locking bar can be inserted through alignment holes 47, 28, and 49 and securely fasten to the locking bar nut 39.

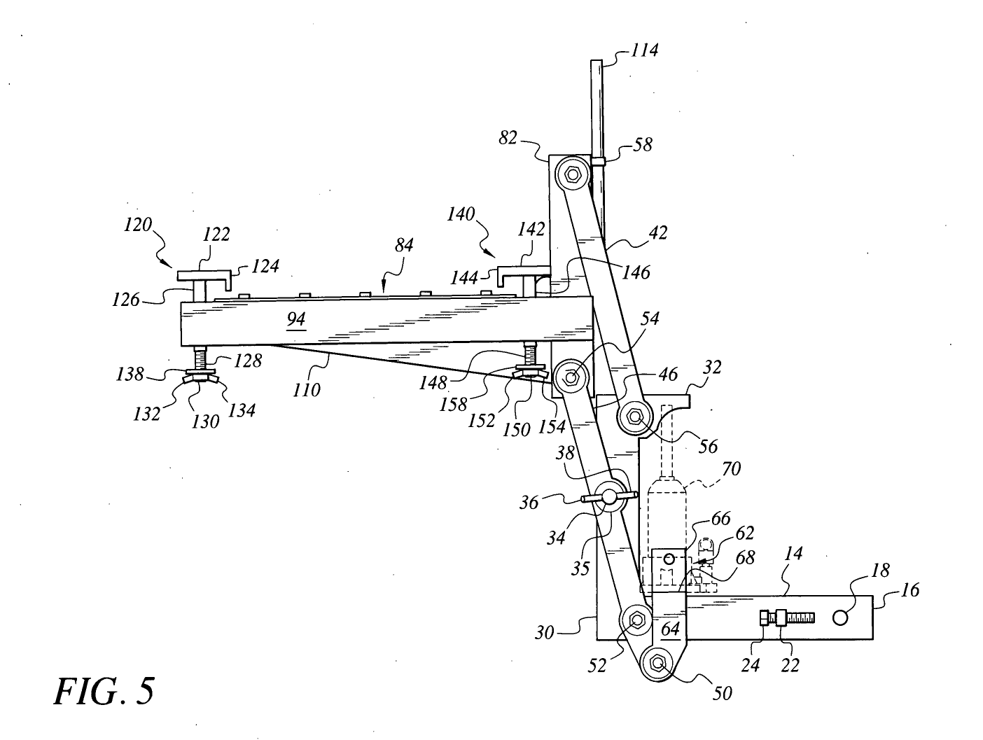

FIG. 5 shows more detail of the handle end portion of the locking bar 34. The handle end portion includes a pair of leverage arms 36 and 38, which extend outwardly at an angle from the handle end portion. Each one of the leverage arms 36, 38 is configured to removably engage a jack handle 114, which is used to tighten the locking bar to the locking bar nut 39. A locking bar washer 35 is disposed between the arms 36, 38 and the lower control arm 46.

As shown in FIGS. 2-4, the carrier platform 84 includes a carrier deck 86 or top plate that is constructed from a single piece of material, such as metal, plastic, or fiberglass. The carrier deck 86 has a forward end 90, a rearward end 92, and two opposing side ends 94, 96. The forward end 90, rearward end 92, side end 94, and side end 96 extend in a downward direction with respect to the carrier deck such that their respected edge portions are integrally joined together by the corner portions thereof to define a rectangular or square shaped carrier platform. The carrier deck 86 and forward end 90 are securely fixed to the rearward support column 82.

The carrier platform 84 is preferably laser cut from a single sheet of steel such that the forward end 90, rearward end 92, and opposing side ends 94, 96 are folded downward and welded together to define a rigid solid surface for carrying the motorcycle. Preferably, the carrier deck 86, the forward end 90, and are welded to the support column 82.

As shown in FIGS. 4-6, the hitch mounted motorcycle carrier 10 include hold down brackets 120 and 140, which are positioned on the carrier platform 84 to secure the foot pegs of the motorcycle to the carrier platform 84. The hold down bracket 120 has a top horizontal bar 122 that engages and holds the foot peg of the motorcycle and a vertical rod 126 that extends downward from the top horizontal bar 122.

The top horizontal bar 122 includes a hook arm 124, which extends from one end portion of the top horizontal bar 122 and is adapted to securely hold the foot peg. The vertical rod 126 has a threaded end portion 128 that is adapted to receive a bracket nut 130, which is attached to the threaded end portion 128 of the vertical rod 126. A washer 138 is disposed between the bracket nut 130 and a lower support plate 102 of the carrier platform 84.

The bracket nut 130 has a pair of angular bars 132 and 134, respectively, which extend at an angle from the bracket nut 130. Each one of the angular arms 132, 134 is constructed and arranged to be removably attached to a hydraulic handle 114 such that the hydraulic handle 114 is slidably engaged with one of the angular ears 132, 134, which provides an extended leverage arm for tightening the bracket nut 130.

The hold down bracket 140 has a top horizontal bar 142 that engages and holds the foot peg of the motorcycle and a vertical rod 146 that extends downward from the top horizontal bar 142. The top horizontal bar 142 includes a hook arm 144, which extends from one end portion of the top horizontal bar 142 and is adapted to securely hold the foot peg. The vertical rod 146 has a threaded end portion 148 that is adapted to receive a bracket nut 150, which is attached to the threaded end portion 148 of the vertical rod 146. A washer 138 is disposed between the bracket nut 150 and a lower support plate 102 of the carrier platform 84.

The bracket nut 150 has a pair of angular bars 152 and 154, respectively, which extend at an angle from the bracket nut 150. Each one of the angular arms 152, 154 is constructed and arranged to be removably attached to a jack handle 114 such that the jack handle 114 is slidably engaged with one of the angular ears 152, 154, which provides an extended leverage arm for tightening the bracket nut 150.

The top horizontal bar 122, 142 and vertical rod 126, 146, respectively, are arranged and constructed with respect to one another to define a hold down member, which has a T-shaped profile. Alternatively, the top horizontal bar 122, 142 and vertical rod 126, 146, respectively, can be configured to define a hold down member, which has a L-shaped profile.

In operation, as illustrated in FIG. 1, the hold down bracket 140 is inserted through the foot peg 602 and extends through the carrier platform 84 to a hold down nut 150, which is positioned underneath the carrier platform 84. Alternatively, the hold down bracket 140 can be position adjacent to the foot peg such that the top horizontal bar 142 and hook arm 144 engage the foot peg 602 to securely hold the motorcycle 600 to the carrier platform 84. The hold down nut 150 is fastened to the hold down bracket 140, which results in pulling the hold down bracket 140 against the foot peg 602 to securely hold the motorcycle 600 to the carrier platform 84.

In a similar manner, the hold down bracket 120 engages the other foot peg (not shown) of the motorcycle 600. The hold down bracket 120 can be inserted through the foot peg of the motorcycle or positioned adjacent to the foot peg such that the top horizontal bar 122 and hook arm 124 engage the foot peg of the motorcycle to securely hold the motorcycle 600 to the carrier platform 84. The hold down bracket 120 extends through the carrier platform 84 to a bracket nut 130, which is positioned underneath the carrier platform 84. The hold down nut 130 is fastened to the hold down member 120, which results in pulling the hold down bracket 120 against the foot peg of the motorcycle to securely hold the motorcycle 600 to the carrier platform 84.

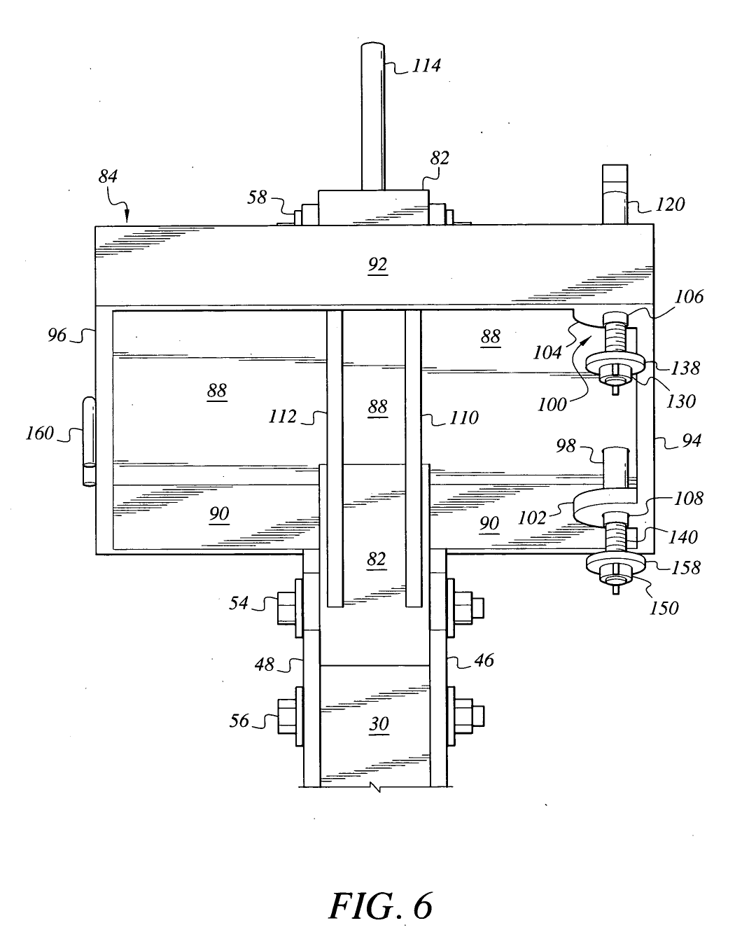

FIG. 6 shows additional details of the underside of the carrier platform 84 and the manner in which the hold down bracket 120 and hold down bracket 140 are secured to the carrier platform 84. The carrier platform includes two lower support plates 102, 104 that are fixed to the carrier platform 84. Support members 98, 100 are disposed between and connected to the lower plates 102, 104 and bottom surface 88 of the carrier deck 86, respectively. The support members 98, 100 are tubular support columns, which are constructed and arranged to provide support to the lower plates 102, 104 as the bracket nuts 150 and 130 are tighten against the lower plates 102, 104. The vertical rods 126, 146 insert through the tubular support column and extend through holes 106 and 108 of the lower support plates 104 and 102, respectively. Washers 138 and 158 engage the lower support plates 104, 102 as the bracket nuts 130, 150 are tighten on the thread end portions 128, 148 of the vertical rods 126, 146.

Referring to FIGS. 5 and 6, diagonal braces 110 and 112 are spaced apart in parallel relationship to each other and are joined to bottom surface 88 of the carrier deck 86. The diagonal braces 110, 112 each have opposite longitudinal ends that are securely joined to rearward support column 82 and to rearward end 92 of the carrier deck 86. Each one of the diagonal braces 110, 112 provides additional support for carrying the motorcycle. Preferably, the diagonal braces 110, 112 are stitch welded to the bottom surface 88 of the carrier deck 86. The diagonal braces 110, 112 are preferably laser cut from a sheet of steel.

As illustrated in FIGS. 2-3, the carrier platform also includes cushioning strips 200, 202 that are disposed on the carrier deck 86 to cushion the motorcycle during transport. The cushioning strips 200, 202 act as dampeners to reduce the vibration between the motorcycle and the carrier platform 84. The cushioning strips 200, 202 are attached to the carrier deck by means of fasteners 204 and 206, respectively. The cushioning strips 200, 202 are preferably polyurethane strips that cushion the motorcycle against the carrier platform 84. The fasteners 204, 206 are preferably rivets, however, other fasteners such as bolts or screws can be used. Alternatively, the cushioning strip 200 can be attached to the carrier deck 84 by means of a bonding adhesive, such as an epoxy, or glue.

As shown in FIGS. 2 and 6, a handlebar tie down hook 160 is incorporated into the carrier platform 84. The handlebar tie down hook 160 is fixed to the side end 96 of the carrier deck 84 and is adapted to receive one end of a handlebar tie down strap (not shown), which has the other end of the handlebar tie down strap attached to the handlebars (not shown) of the motorcycle. The handlebar tie down hook 160 is preferably U-shaped.

Referring again to FIGS. 2-4, an accessory mounting hole 26 is disposed on the hitch engaging end 16 for mounting accessories, such as a fuel container holder, a luggage holder, or spare tire rack. A jack handle 114 that is adapted to operate the hydraulic jack 70 is removably attached to the rearward support column 82. A jack collar 116 is fixed to the rearward support column and is adapted to hold the jack handle 114. A support cup 118 is fixed to the rearward support column 82 and is configured to have the hydraulic jack handle 114 slidably attach to the jack handle support cup 118.

It is to be understood that the present invention is not limited to the embodiments described above, but encompasses any and all embodiments within the scope of the following claims.

We claim:

1. A hitch mounted motorcycle carrier for transporting a motorcycle, comprising:
a hitch engaging body having a hitch engaging member configured to be removably joined to a trailer hitch receiver disposed on a motor vehicle and a forward support column extending upwardly from one end of said hitch engaging member;
a carrier housing having a carrier platform for carrying a motorcycle thereon;
at least one control arm having a first end portion and a second end portion, the first end portion being rotatably connected to said hitch engaging body, and the second end portion being rotatably connected to said carrier housing;
at least one hold down bracket positioned on said carrier platform for securing the motorcycle to the carrier platform; and
an actuating assembly connected to said at least one control arm and adjoined to said hitch engaging body, said actuating assembly operable to effect a movement of said carrier housing with respect to said hitch engaging body for lifting and lowering the motorcycle.

2. The hitch mounted motorcycle carrier according to claim 1, further comprising:
a rearward support column securely fixed to a portion of said carrier platform, said rearward support column being rotatably connected to said at least one control arm.

3. The hitch mounted motorcycle carrier according to claim 1, further comprising:
at least one diagonal brace joined to said carrier platform and said rearward support column for supporting and stabilizing said carrier housing.

4. The hitch mounted motorcycle carrier according to claim 1, further comprising:
at least one cushioning strip attached to said carrier platform for dampening the vibration between said carrier housing and the motorcycle being transported thereon.

5. The hitch mounted motorcycle carrier according to claim 1, further comprising a base wall and two opposing sides walls integrally connected to the base wall and extending in a downwardly direction therefrom to define a saddle for supporting a hydraulic jack.

6. The hitch mounted motorcycle carrier according to claim 1, wherein said at least one hold down bracket includes a vertical rod extending from a top horizontal bar having a vertical rod extending downward thereof, the vertical rod having a threaded end portion which is adaptable to receive a bracket nut.

7. The hitch mounted motorcycle carrier according to claim 6, wherein bracket nut has a pair of angular bars extending at an angle from the bracket nut, each one of the angular arms being adaptable to removably attached to a jack handle.

8. The hitch mounted motorcycle carrier according to claim 6, wherein the top horizontal bar has at least one hook arm extending downward from one end portion of the top horizontal, the hook arm being adaptable to securely hold the foot peg.

9. The hitch mounted motorcycle carrier according to claim 1, wherein said at least one hold down bracket is a T-shaped hold down member having a threaded end portion and a bracket nut fasten to the threaded end portion of the T-shaped hold down member, the T-shaped hold down member being configured to engage a foot peg of the motorcycle for holding the motorcycle to the carrier platform.

10. The hitch mounted motorcycle carrier according to claim 9, wherein the T-shaped hold down member has a hook arm, the hook arm being configured to engage the foot peg of the motorcycle to securely hold the motorcycle to the carrier platform

11. The hitch mounted motorcycle carrier according to claim 1, wherein said at least one hold down bracket is a L-shaped hold down member having a threaded end portion and a bracket nut fasten to the threaded end portion of the L-shaped hold down member, the L-shaped hold down member being configured to engage a foot peg of the motorcycle for holding the motorcycle to the carrier platform.

12. The hitch mounted motorcycle carrier according to claim 1, further comprising a locking bar removably connected to said at least one control arm, the locking bar being operable to lock the carrier housing at an upright position in relation to said hitch engaging body for transporting the motorcycle.

13. The hitch mounted motorcycle carrier according to claim 12, wherein the locking bar further comprises a threaded end portion, an opposing handle end portion having a pair of leverage arms extending outwardly at an angle from the handle end portion, and a locking bar nut disposed on said at least one control arm for securely fastening the locking bar, each one of the pair of leverage arms being configured to removably engage a jack handle for tightening the locking pin to the locking bar nut.

14. A hitch mounted motorcycle carrier for transporting a motorcycle, comprising:
a receiver hitch bar removably joined to a trailer hitch receiver disposed on a motor vehicle;
a forward support column having an upper section and a lower section, the lower section being securely fixed to the receiver hitch bar, the upper section having an upper top plate fixed thereon and extending forwardly from said support column;
a rearward support column having an upper section and a lower section;
a carrier deck mounted to the rearward support column for carrying a motorcycle thereon;
a movable control arm assembly rotatably connected to said support column and to said receiver hitch bar and configured to lift and lower said carrier deck;
at least one hold down bracket having a vertical rod extending from a top horizontal bar, said at least one hold down bracket positioned on said carrier deck for holding the motorcycle to the carrier deck; and
an actuating assembly having a saddle connected to said control arm assembly and a hydraulic jack disposed on said saddle and extending upwardly to adjoin the upper top plate of said forward support column, said hydraulic jack being operable to effect a movement of said carrier deck with respect to said receiver hitch bar for lifting and lowering the motorcycle.

15. The hitch mounted motorcycle carrier according to claim 14, wherein said movable control arm assembly includes two upper control arms having forward end portions extending on opposite sides of the upper section of said forward support column, each one of the forward end portions being rotatably connected to said forward support column and having rearward end portions extending on opposite sides of the upper section of said rearward support column, each one of the rearward end portions being rotatably connected to said rearward support column.

16. The hitch mounted motorcycle carrier according to claim 14, wherein said movable control arm assembly includes two lower control arms having forward end portions extending on opposite sides of the lower section of said forward support column, each one of the forward end portions being rotatably connected to said forward support column and having rearward end portions extending on opposite sides of the lower section of said rearward support column, each one of the rearward end portions being rotatably connected to said rearward support column.

17. The hitch mounted motorcycle carrier according to claim 14, further comprising a locking bar having a handle end portion, the handle end portion includes a pair of leverage arms extending at an angle from the handle end portion, each one of the leverage arms being configured to removably engage a jack handle.
